(19) United States
(12) Patent Application Publication
(10) Pub. No.: US 2010/0280955 A1
(43) Pub. Date: Nov. 4, 2010

(54) SYSTEMS AND METHODS FOR VERIFYING IDENTITY

(75) Inventors: John Anderson Fergus Ross, Niskayuna, NY (US); Michael Hartman, Clifton Park, NY (US); Bruce Barnett, Troy, NY (US); John Erik Hershey, Ballston Lake, NY (US)

Correspondence Address: GE TRADING & LICENSING, 1 RESEARCH CIRCLE, ATTN: BRANDON, K1 - 2A62A, NISKAYUNA, NY, 12309, US

(73) Assignee: General Electric Company, Schenectady, NY (US)

(21) Appl. No.: 12/433,144

(22) Filed: Apr. 30, 2009

(51) Int. Cl. H04L 9/32; G06F 17/00; G06Q 30/00; G06N 5/02; G06Q 40/00

(52) U.S. Cl. 705/64; 235/380; 705/18; 705/17; 706/52; 705/44

(57) ABSTRACT

Systems and methods of verifying identity through the use of a plurality of identifying devices is provided. The identity information may be acquired electronically from a plurality of identity devices, which may include credit cards, cell phones, or other personal items fitted with wireless communicators such as RFID tags, for example. In various embodiments, the transaction may be approved or denied based on a number of factors, including the number identity devices, the types of identity information provided by the identity devices, and the level of security specified for the requested transaction.

### BACKGROUND

The subject matter disclosed herein relates generally to identity verification and, more specifically, to acquiring identity information from two or more devices to determine whether to allow a transaction.

In recent years, many kinds of marketplace transactions have tended to become more electronically based. Transactions such as withdrawing cash from a bank account, purchasing an item at a retail store, purchasing movie tickets, etc. are commonly performed using credit cards, cell phones, or other electronic devices. Conducting such transactions electronically is fast and convenient and may, in some cases, reduce the need for a clerk or cashier to be involved in the transaction. Often, the identity of the person making a purchase may be established by providing a single identification device, such as a credit card or driver's license, for example. Moreover, simply possessing the device used to conduct the transaction may often be considered sufficient evidence to verify identity and allow the transaction. However, if identity can be proven by presenting only one such device, the risk of falsely approving a transaction increases, due to the possibility of an unapproved person acquiring the single device. It may be desirable, therefore, to provide a system that acquires identity information electronically from two or more devices before approving a transaction.

### BRIEF DESCRIPTION

Embodiments of the present invention provide systems and methods for acquiring identity information from a variety of electronic devices to determine whether to approve a requested transaction. The identity information may be acquired electronically from one or more “identity instruments,” which may be in the possession of the person requesting the transaction. Examples of such identity instruments may include credit cards, mobile phones, or other personal effects or possessions that may be fitted with a wireless transmitter, such as clothing, a keychain, an automobile, etc. In various embodiments, identity information may be acquired from a plurality of identity instruments and the transaction may be approved or denied based on the number of identity instruments, the types of identity information provided, and the level of security specified for the requested transaction. By verifying a person's identity electronically, using a plurality of identity instruments, identity may be quickly verified while also reducing the risk of identity theft.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram, illustrating an embodiment of an identity verification system;

FIG. 2 is a block diagram of the system of FIG. 1, illustrating an embodiment of a reader;

FIG. 3 is a block diagram, illustrating an identity verification system wherein the reader communicates with a single identity instrument;

FIG. 4 is a block diagram, illustrating an identity verification system with two or more readers;

FIG. 5 is a flow chart, illustrating a method of performing a transaction using the identity verification systems of FIG. 1-4.

### DETAILED DESCRIPTION

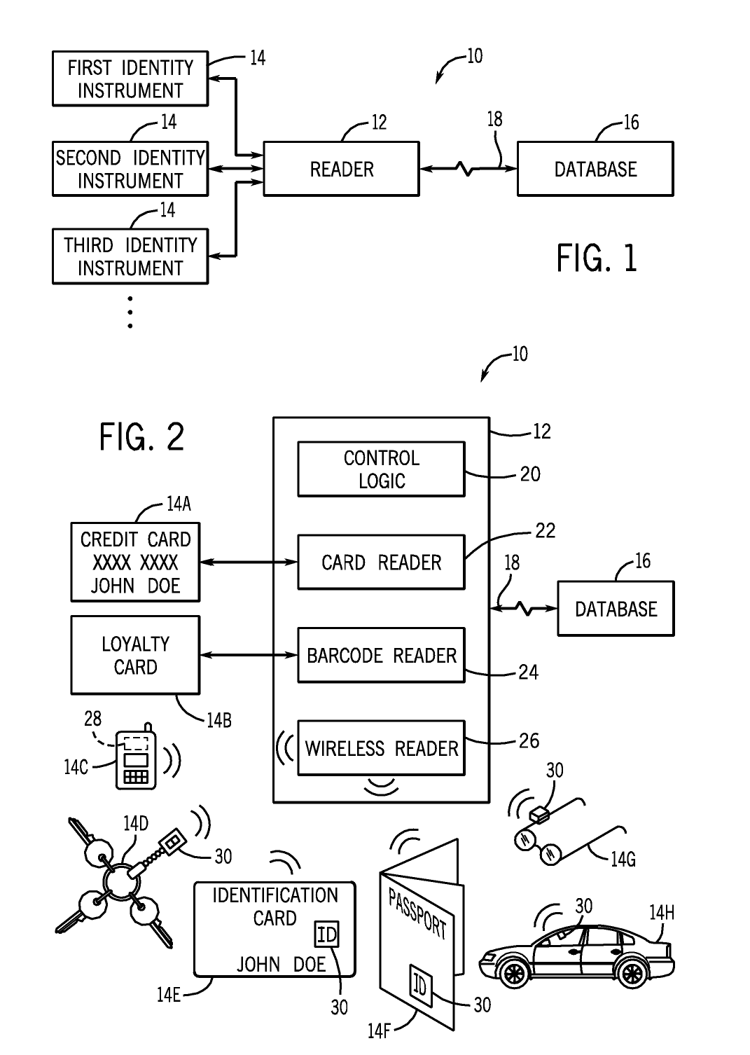

FIG. 1 is a block diagram, illustrating an embodiment of an identity verification system. As shown in FIG. 1 the identity verification system 10 may include a reader 12 configured to acquire identity information from two or more identity instruments 14 that may be in the possession of a customer. For purposes of the present disclosure, the term “customer” is used generally to refer to any person whose identity, or right to make a particular transaction, is to be verified. The reader 12 may be any suitable kind of electronic device used to execute a transaction, such as point of sale (POS) device, an ATM, or a vending machine, for example. Upon the initiation of a transaction, the reader 12 may acquire identity information from two or more of the identity instruments 14. As will be described further below, the identity information may include any information or instructions that may be useful in identifying the customer, such as the customer's name, an identification code, or other encoded information, which may be public or private. It should be noted that the present techniques do not necessarily require that actual the “identity” of the transacting person be detected, known or verified, although some transactions may require this. Rather, the information detected, verified or otherwise processed will include any information sufficient to warrant authorization of a desired transaction, such as personal data, group data, affiliation data, property data, and so forth. As used herein, the term “identity” should be understood to include any such data, or other data that may be used for equivalent purposes.

Additionally, the reader 12 may be coupled to a database 16 through a network 18. The database 16 may be used to consummate the requested transaction, such as a bank withdrawal, purchase, etc. Moreover, the database 16 may include information used by the reader 12 to verify the customer's identity. For example, if the transaction is to be approved upon receiving a valid identification code from the identity instruments 14, the database 16 may include a list of identification codes associated with particular customers, and the validity of the identification code may be determined by comparing the identification code provided by the identity instruments 14 to the information stored in the database 16.

Using the system 10 described above, various techniques for verifying identity may be implemented, some of which will be described below. In some embodiments, the customer's identity may be verified if valid identifying information is provided by a specified number of particular identity instruments 14. In other embodiments, the customer's identity may be verified if valid identifying information is provided by a subset of several possible identity instruments 14. The particular technique used to verify identity may vary depending on, among other things, the level of security desired, the type or size of the transaction attempted, other transactions performed within a specific time frame, and so forth. For example, various techniques may use cryptography to reduce the likelihood that the identity information stored on any single identity instrument 14 may be used illicitly. Various non-limiting examples of techniques used in the system 10 to verify identity are described below.

In one embodiment, the reader 12 may calculate a confidence score (or an equivalent derived value or rating) based on the identity information provided by the identity instruments 14, and the transaction may be approved or disapproved after comparing the confidence score to a threshold confidence level applicable to the transaction. For example, the confidence score may be related to the number of identity instruments 14 that have provided valid identity information. In this way, a greater number of identity instruments 14 may increase the confidence score and, therefore, increase the likelihood that the transaction will be approved. The threshold confidence level may be used to set a security level for various types of transactions, and may relate to the number of identity instruments 14 expected to provide valid identity information before approving a transaction. For example, certain low security transactions may be associated with a low threshold confidence level, wherein a single identity instrument may be used to verify identity, while high security transactions may be associated with a higher threshold confidence level, wherein two, three, four, five or more identity instruments 14 may be used to verify identity.

Furthermore, some identity instruments 14 may be more reliable indicators of identity than others. Therefore, in the calculation of the confidence score each of the identity instruments 14 may be weighted according to the relative likelihood that the type of instrument provided would only be in the possession of the customer bearing such item. In some embodiments, therefore, the identity information provided by the identity instruments 14 may include a weighting factor that indicates the weight to be given to the particular identity instrument 14 providing the identity information.

For example, in one embodiment, a first identity instrument 14 may be given a weight of 4x, a second and third identity instrument 14 may both be given a weight of 2x, and a forth identity instrument 14 may be given a weight of 1x. Furthermore, the threshold confidence level of the requested transaction may be 5x. With this arrangement, the requested transaction may be approved if the customer possesses the first identity instrument 14 and any one of the other three identity instruments 14 (e.g. 4x+2x=6x). If however, the customer is not in possession of the first identity instrument 14, the transaction may still be approved if the customer possesses all three of the second, third, and forth identity instruments 14 (e.g. 2x+2x+1x=5x).

For another example, in one embodiment, a certain device or possession of the customer may be designated as a “gateway” identity instrument 14, such that no transaction may be approved without presenting at least the gateway identity instrument 14 plus at least one other identity instrument 14. For example, the gateway identity instrument 14, such as mobile phone, may be given a relative weight of 10x, while several additional identity instruments 14 may be given a weight of 1x. Furthermore, the threshold confidence level of a requested transaction may be 12x. With this arrangement, the requested transaction may only be approved if the customer possesses the mobile phone and any two additional identity instruments 14 (10x+1x+1x=12x).

In some embodiments, the system 10 may, in some embodiments, use a method of cryptography, such as “secret sharing,” in which case, the identity information provided by some or all of the identity instruments 14 may include encoded data that may be used to reproduce an identity verification code. In this embodiment, the identity information contained on each of the identification instruments 14 may include code variables relating to an identity verification code and instructions for reproducing the identity verification code from the code variables provided. Both the code variables, referred to herein as the secret sharing data (SSD), and the instructions for reproducing the identity verification code, referred to herein as the secret sharing identification information (SSID), may be provided to the reader 12 so that the reader can reproduce the identity verification code according to the data and instructions provided. In such an embodiment, the approval of a transaction may include acquiring the SSD and SSID from the available identity instruments 14, using the acquired data to calculate the identity verification code, and verifying the validity of the identity verification code by comparing the identity verification code to information contained in the database 16.

In this embodiment, unique sets of code variables may be distributed among a total number of identity instruments 14, T, such that a predetermined subset of identity instruments 14, K, may be used to reproduce the identity verification code. For example, if T equals two and K equals two, then code variables are distributed among two identity instruments 14 and both of the identity instruments 14 are used to reproduce the identity verification code. For another example, if T equals four and K equals three, then code variables may be distributed among four identity instruments 14, but the identity verification code may be determined based on the code variables provided by any three of the identity instruments 14.

It will be appreciated that in a secret sharing system no single identity instrument alone will provide significant clues regarding the identity verification code. For example, in a secret sharing system, the number of code variables provided by each identity instrument may equal the number of variables in the identity verification code. In the secret sharing system, therefore, no single identity instrument 14 may be used to determine the identity verification code or to even significantly narrow the range of additional variables needed to reproduce the identity verification code. In this way, the security of the system 10 may not be compromised in the event that a single identity instrument 14 were subject to illicit use by an unauthorized user, because the information provided by a single identity instrument 14 may not be used to provide significant information about the identity verification code. As can be appreciated from the examples given above, a wide range of techniques for approving a transaction may be implemented using the system 10, and the above examples are not intended to describe all of the possible embodiments encompassed by the present disclosure.

Other aspects of the system 10 may be better understood with reference to FIG. 2, which is a block diagram of the system 10 of FIG. 1, illustrating an embodiment of a reader 12. As shown in FIG. 2, the reader 12 may include a control logic 20 that is programmed to control the various the operational aspects of the reader 12 described herein, such as communicating with the database 16, calculating a confidence score, decrypting encoded information, etc. The control logic 20 may be hardware based, software based, or some combination thereof. The reader 12 may also include a credit card reader 22 for receiving data from a bank card 14A, such as a credit card or debit card, for example. The reader 12 may also include a barcode reader 24 for, among other things, acquiring data from a customer loyalty card 14B. Additionally, the reader 12 may include a wireless reader 26 for acquiring information from a variety of devices wirelessly. Moreover, the card reader 22, barcode reader 24, and wireless reader 26 may be used to acquire identity information from the identity instruments 14A-14H. In one embodiment, the reader 12 may be a point of sale device.

Some of the identity instruments 14 may include a wireless communications device such as a near field communications (NFC) device 28 or RFID tag 30. As such, the reader 12 may acquire identity information from the identity instruments 14 by transmitting an interrogation signal and listening for any return signals from the identity instruments 14. The return signals sent by the identity instruments 14 back to the reader 12 may include the identity information. The identity information may then be used by the reader 12 to verify identity and approve the requested transaction. The identity instruments 14 may be any device or possession of a customer that may be suitably fitted with a wireless transmitter. A non-exclusive list of possible wireless identity instruments 14 may include a cell phone 14C, a keychain 14D, an identification card 14E, passport 14F, eyeglasses 14G, or an automobile 14H.

Identity information may also be acquired by the reader 12 non-wirelessly. For example, if additional identity information is requested by the reader 12, the reader 12 may prompt the customer to swipe additional bank cards 14A through the card reader 22 or to present a loyalty card 14B to be read by the barcode reader 24. Furthermore, one of the identity instruments 14 may also be used to initiate the transaction.

A wide range of possible transactions may be performed using the system 10 described in FIG. 2, including sales, banking, or any other transaction wherein identity is verified prior to consummation of the transaction. For example, in one embodiment, a customer may swipe the bank card 14A through the card reader 22 to initiate a store purchase or an ATM cash withdrawal. The magnetic strip on the bank card 14A may include relevant financial information used in the transaction as well as additional identity information, such as the SSID and SSD described above. Upon swiping bank card 14A, the bank card 14A may transmit the financial information as well as the identity information to the reader 12. The reader 12 may then initiate a wireless search for identity information by transmitting an NFC-based and/or RFID-based interrogation signal. In response to the interrogation signal, one or more of the identity instruments 14 within the vicinity of the reader 12 may send additional identity information to the reader 12. For example, in the case of a cash withdrawal at a drive-through ATM, an RFID device 30 coupled to the windshield of the customer's automobile may send the identity information. After receiving the identity information provided by the various identity instruments 14, the reader 12 may then allow or disallow the transaction based on the sufficiency of the identity information provided.

For another example, in some embodiments, the reader 12 may be used to provide entry into a secured facility. In such embodiments, a person seeking entry may pass through a checkpoint that includes a reader 12. The reader 12 may be configured to detect the presence of a person seeking admittance, at which time the reader 12 may conduct a search for identity instruments 14 by transmitting a wireless interrogation signal. Upon detection of the wireless interrogation signal, one or more identity instruments 14, such as an ID card 14E or a keychain 14D, may send a return signal carrying the identity information. In the case of a vehicular checkpoint, one of the identity instruments 14 may be the vehicle 14H equipped with an RFID tag 30. The reader 12 may then allow or disallow entry based on the sufficiency of the identity information provided by the identity instruments 14. Furthermore, in the case of an unmanned checkpoint, the reader 12 may allow entry electronically, such as by unlocking a door or opening a gate.

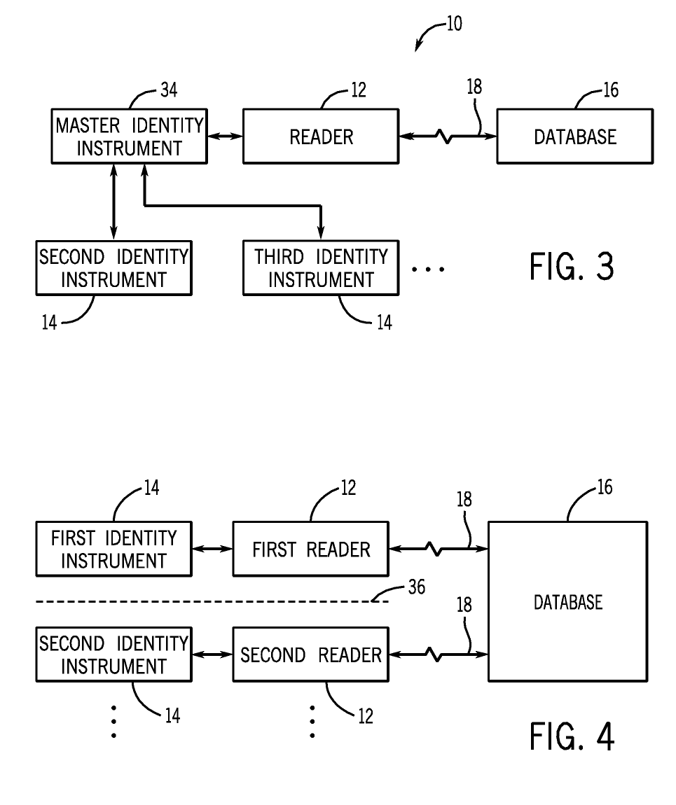

It will be appreciated that in the embodiments described above, a single reader 12 serves to acquire the provided identity information, and that all of the identity instruments 14 are within close proximity to the reader 12. These aspects are not intended, however, to be limitations of the present invention. For example, in one embodiment, which is described below in reference to FIG. 3, the reader 12 may communicate with a single identity instrument 14, which gathers identity information from other identity instruments 14 and passes the identity information along to the reader 12. Additionally, in another embodiment, which is described below in reference to FIG. 4, the identity information may be acquired by two or more readers 12, which may be at different locations.

Turning first to FIG. 3, a block diagram of a system 10 is shown wherein the reader 12 communicates with a single identity instrument 34. As in FIG. 1, the system 10 shown in FIG. 3 includes a reader 12 coupled to a database 16 though a network 18. In this embodiment, however, the reader 12 communicates directly with only the first identity instrument, referred to herein as the “master” identity instrument 34, and the additional identity instruments 14 communicate with the master identity instrument 34 rather than the reader 12. Accordingly, the master 34, which may be a mobile phone for example, may be configured to acquire identity information from the additional identity instruments 14, add the acquired identity information to the identity information contained in the master 34, and pass the sum of the identity information to the reader 12. In a secret sharing system, identity information contained on the master 34 and the other identity instruments 14 may include the SSID and SSD describe above, and the master 34 may be configured to calculate the identity verification code based on the SSID and SSD data provided. The identity verification code may then be sent to the reader 12, which verifies identity and allows or disallows the requested transaction. In this way, the design of the reader 12 may be simplified due to the fact that the reader 12 may be configured to communicate with only the master identity instrument 34.

Turning now to FIG. 4, a block diagram of a system with two or more readers is shown, in accordance with certain embodiments of the present techniques. As shown in FIG. 4, the system 10 may include more than one reader 12, and the readers 12 may be at different locations as indicated by the dashed line 36. Furthermore, each of the readers 12 may be coupled to a database 16 though a network 18. During a transaction, identity information may be acquired from the first identity instrument 14 by the first reader 12 and from the second identity instrument by the second reader 12, and so one for each reader 12. Furthermore, each reader 12 may acquire identity information from two or more identity instruments 14. The totality of the acquired identity information may be sent to the database 16, which may evaluate the identity information to determine whether to allow the requested transaction, e.g. calculating a confidence score or, in a secret sharing system, calculating the identity verification code. The database 16 may then send a signal to one or both of the readers 12 indicating whether the transaction has been approved. In this way, a requested transaction may be approved based on identity information provided by two or more people at separate locations.

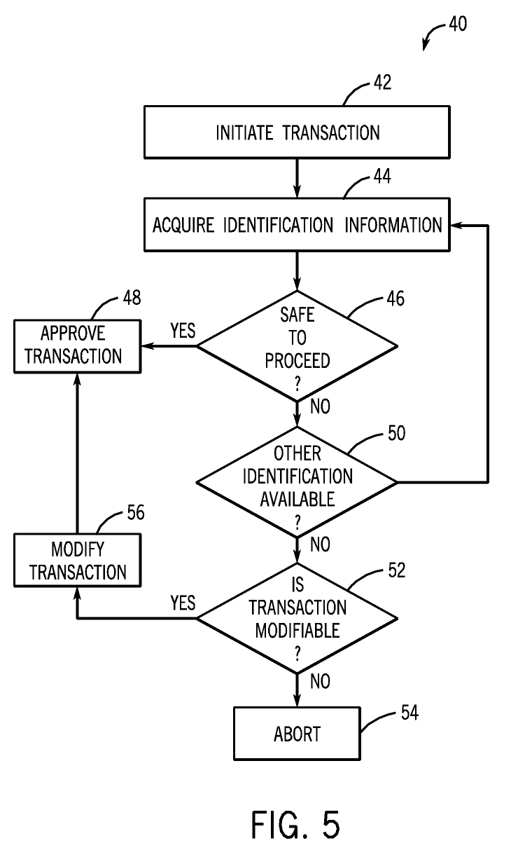

Turning now to FIG. 5, a method of performing a transaction using the system described above is shown, in accordance with embodiments. As shown in FIG. 5, method 40 starts at step 42, wherein a transaction is initiated. As described above, the transaction may be initiated by the swiping of a bank card 14A. Additionally, in some embodiments, a transaction may be initiated wirelessly by any other identity instrument, such as an ID card 14E or mobile phone 14C, for example.

After the initiation of the transaction, the method 40 may advance to step 44, wherein identity information is acquired. As discussed above, in relation to FIG. 1, the identity information may include any suitable public or private information that may be used to verify identity. For example, the identity information may include code variables pertaining to an encryption technique, such as the secret sharing technique described above in relation to FIG. 1. For another example, the identity information may include the customer's name or a secret identification number associated with the customer. Furthermore, the identity information may include a weighting factor that determines the relative weight that a particular identity instrument 14 should be given in verifying the customer's identity. In some embodiments, the identity information may be first acquired from the identity instrument 14 used to initiate the transaction.

Next, at step 46, a determination is made as to whether identity has been sufficiently established so that it is safe to proceed with the present transaction. In secret sharing embodiments, determining whether identity has been sufficiently established may involve calculating the identity verification code based on the code variables provided. In such embodiments, the identity verification code may be validated by comparing it to information stored on the database 16. In other embodiments, determining whether identity has been sufficiently established may involve calculating a confidence score based on the identity information provided and comparing the confidence score to a threshold confidence level. The threshold confidence level may be determined based on the type of transaction requested. For example, if the requested transaction involves a purchase, the threshold confidence level may be based on the overall cost of the purchase, with the threshold confidence level increasing for higher cost purchases. For another example, if the transaction involves entry into a secure location, various locations within a facility may be assigned higher or lower threshold confidence levels, depending on the relative level of security desired for each location. In such embodiments, it will be appreciated that certain low threshold transactions, such as low cost purchases, may be approved based on the identity information provided by a single identity instrument 14.

If the customer identity is sufficiently verified, e.g. the identity verification code is validated or the calculated confidence score is above the threshold confidence level, then the method may advance to step 48, wherein the transaction is approved. If the customer identity is not sufficiently verified, however, then the method 40 may advance to step 50, wherein a determination is made as to whether additional identity information is available. During this step, the reader 12 may, in some embodiments, search for additional identity instrument 14 wirelessly or prompt a customer to provide an additional identity instrument 14 to be scanned, as discussed above in relation to FIG. 2.

If additional identity instruments are available, then the method 40 may return to step 44, wherein the new identity information is acquired and combined with the previously provided identity information. Steps 44, 46, and 50 may be repeated until either no additional identity instruments 14 are available or the transaction is approved.

If additional identity instruments are not available, then the method 40 may advance to step 52, in which a determination is made as to whether the transaction may be modified, e.g. reducing the threshold confidence level of the transaction by reducing the purchase cost, etc. If the transaction is not modifiable, then the method 40 advances to step 54 and the transaction is aborted. Otherwise, if the transaction is modifiable, then the method 40 proceeds to step 56 and the transaction is modified.

The modification of the transaction may include any suitable modification that allows the transaction to be approved. For example, in some embodiments, biometric information may be acquired from the customer, such as a finger print, photograph, or eye scan, for example. The biometric information may then be compared to other biometric information stored in the database 16, or the biometric information may be stored in the database 16 to allow for recourse in the event of a wrongfully approved transaction. In other embodiments, the modification of the transaction may involve providing additional forms of non-electronic identification, such as a social security card or a driver's license, for example. The non-electronic identification may be received by an operator of the reader 12 who may then manually approve the transaction or reduce the threshold confidence level applied to the transaction, accordingly. In yet other embodiments, the modification of the transaction may involve reducing the monetary cost of the transaction, such as by eliminating certain items from the purchase. As such, the threshold confidence level used for the transaction may be reduced to a level that is below the confidence score calculated based on the identity information provided by the identity instruments 14. After suitably modifying the transaction, the method may then proceed to step 48, wherein the transaction is approved.

The systems and methods described above may provide fast, secure, electronically-based techniques for verifying identity. Technical effects of the invention include the approval or denial of a transaction, such as a financial transaction or admittance to a secure area, based on identity information provided by a plurality of electronic devices.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system comprising at least one reader configured to receive identity information electronically from at least two identity instruments and to allow or disallow a transaction based on the identity information received from the at least two identity instruments.

2. The system of claim 1, wherein the reader is configured to request identity information from at least one identity instrument wirelessly and wherein the at least one identity instrument is configured to transmit the identity information to the reader wirelessly.

3. The system of claim 1, wherein the reader comprises a point of sale device configured to initiate a transaction based on a transaction request from one of the identity instruments.

4. The system of claim 1, wherein the at least two identity instruments comprise a credit card and a mobile phone.

5. The system of claim 1, wherein one of the at least two identity instruments comprises a master identity instrument configured to acquire identity data from the other of the at least two identity instruments and transmit the acquired identity data to the reader.

6. The system of claim 1, wherein the at least one reader comprises two readers coupled through a network to a database.

7. The system of claim 1, wherein the identity information comprises code variables corresponding to an identity verification code, and wherein the reader is configured to calculate the identity verification code based on the code variables provided by the at least two identity instruments.

8. A point of sale terminal, comprising:
a card reader configured to receive data from a first identity instrument electronically, the data comprising financial data used to perform a financial transaction and a first set of identity data used to verify identity;
a near field communications device configured to interrogate at least a second identity instrument and receive at least a second set of identity data used to verify identity; and
a control logic configured to verify the identity of a customer based on the first and at least second set of identity data.

9. The point of sale terminal of claim 8, wherein the first identity instrument comprises a bank card and the second identity instrument comprises a mobile phone.

10. The point of sale terminal of claim 9, wherein the first and at least second set of identity data comprise code variables corresponding to an identity verification code and wherein the control logic is configured to decrypt the identity verification code based on the code variables.

11. The point of sale terminal of claim 8, wherein the control logic is configured to calculate a confidence score representative of the degree to which identity has been verified, wherein the confidence score is based on the first and at least second set of identity data.

12. The point of sale terminal of claim 11, wherein the first and second set of identity data comprise weighting factors representative of the degree to which the identity instrument providing the identity data may be relied on to verify identity, and wherein the weighting factors are used in the calculation of the confidence score.

13. The point of sale terminal of claim 11, wherein the control logic is configured to determine a threshold confidence value based on the monetary cost of the transaction, and wherein the control logic is configured to verify identity by comparing the confidence score to the threshold confidence value.

14. A method of performing a transaction, comprising:
receiving a request for a transaction;
receiving identity information electronically from two or more identity instruments; and
allowing or disallowing the transaction based on the identity information received from the two or more identity instruments.

15. The method of claim 14, comprising determining a threshold confidence level based on a level of security specified or calculated for the requested transaction.

16. The method of claim 15, comprising determining a confidence score based on the identity information provided by the two or more identity instruments, wherein allowing or disallowing the transaction comprises comparing the confidence score to the threshold confidence level.

17. The method of claim 16, wherein calculating the confidence score comprises applying a weighting factor assigned to the identity information based on the particular identity instrument providing the identity information.

18. The method of claim 14, comprising modifying the transaction before allowing the transaction if the identity information received from the two or more identity instruments is valid but insufficient to allow the requested transaction.

19. The method of claim 14, wherein the identity information comprises code variables corresponding to an identity verification code, and wherein allowing or disallowing the transaction comprises reproducing the identity verification code based on the code variables provided by the two or more identity instruments.

20. The method of claim 19, wherein code variables are distributed among a total number of identity instruments and wherein reproducing the identity verification code comprises calculating the identity verification code using the code variables provided by a subset of the total number of identity instruments.
